(19) United States
(12) Patent Application Publication
(10) Pub. No.: US 2001/0054071 A1
(43) Pub. Date: Dec. 20, 2001

(54) Audio/video conference system for electronic caregiving

(76) Inventor: Gerald E. Loeb, Los Angeles, CA (US)

Correspondence Address: Oppenheimer Wolff & Donnelly LLP, 45 South Seventh Street, Suite 3300, Minneapolis, MN, 55402-1609, US

(21) Appl. No.: 09/803,406

(22) Filed: Mar. 9, 2001

Related U.S. Application Data
(60) Provisional application No. 60/188,578, filed on Mar. 10, 2000.

(51) Int. Cl. G06F 15/16

(52) U.S. Cl. 709/205

(57) ABSTRACT

A conference system for electronic caregiving is described. A one-on-one audio/video-call system allows communication between an elderly or disabled user and caregiver using audio, video and/or data. The system includes two communication systems—one for the user and one for the caregiver. Each communication system includes a console coupled to a television. The console has a digital processor, storage, software, and connections to telephone equipment, channel tuner, a video camera, and steering for the video camera. A remote control issues commands to the console to initiate or accept calls to the other communication system. The phone line is used to carry the audio portion of the call while the network is used to carry any video and/or data portion of the call. In some embodiments, a passkey allows the caregiver's communication system to control the user's communication system without any interaction by the user. In other embodiments, more than one video camera is used for a communication system. A microphone can be coupled to the remote control to collect the audio channel for the call.

### CROSS REFERENCE TO RELATED APPLICATIONS

This application claims the benefit of U.S. Provisional Application No. 60/188,578, filed on Mar. 10, 2000, entitled “INTUITIVELY USABLE INSTRUMENT FOR VIRTUAL VISITS,” which is incorporated herein by reference.

### BACKGROUND OF THE INVENTION

The system relates to audio/video conferencing, and in particular to an audio/video conference system particularly suited to one-on-one conferences for electronic caregiving, where the system provides the video portion of the conference through the user's television set.

A recent study by the U.S. Government reported that in August 2000, more than half of all United States households had a personal computer and that over 40% of households had some type of access to the Internet. That federal study found that over 116 million Americans were online, with the most popular online activity being sending e-mail. Thus, the PC with Internet access is rapidly becoming a key consumer communication device.

While e-mail is still the dominant method of Internet communications, electronic conferencing—which offers both voice and video connectivity—is of course an attractive improvement. In 1964, AT&T and General Electric teamed up and introduced the Picturephone™ system, which was designed to transmit pictures in parallel with voice during a telephone call. However, the Picturephone never became popular—in part because the necessary infrastructure for such technology was not available.

For the past few years, the rapidly expanding wireless phone industry has promised its own version of the Picturephone. This technology, known as “3G,” has promised to deliver high-speed data rates to mobile devices. While telecommunication providers are spending hundreds of billions of dollars in research and development for a 3G infrastructure, in reality, South Korea has the only 3G service which is currently available. The primary hurdle for 3G—and other forms of electronic conferencing—is how to provide the bandwidth that such video streaming requires. For example, industry experts say that a 3G network would need to be able to deliver 2 million bits of information every second. A team of Jupiter Research analysts summarized the situation by saying: “Mass market video conferencing has remained a pipe dream since the first videophones were showcased at the World's Fair in 1960.”

Although branded as a pipe dream, corporations continue to invest large amounts of research and development into electronic conferencing because once achieved, it could supplant the telephone and be used for innumerable applications, including everyday home use, long-distance learning, corporate conference calls, and the like.

One particularly attractive use of electronic conferencing would be for what can be described as “electronic caregiving,” in which friends, family, doctors, pharmacists, and other professional caregivers use electronic conferencing to provide for the emotional well-being and physical safety of elderly and physically disabled individuals with limited mobility. By interacting with the individuals on a regular basis through such audio/video calls, such caregivers could more realistically assess their emotional and physical condition and needs.

The population of elderly and house-bound individuals will rise steadily as a result of demographic factors and the success of medical and surgical measures to prolong life in patients with chronic illnesses. In the past, such individuals often lived with (or at least near) an extended family of children and other relatives who could monitor their well-being by observing them physically on a regular basis. This support network has been declining as a result of many factors, such as increased career mobility and declining familial ties through divorce and remarriage. Individuals who could live in their own homes are often moved into much more expensive retirement homes and extended care facilities simply because of the uncertainty about their day-to-day condition. On the other hand, individuals who become essentially housebound in their own homes suffer from loneliness, depression, poor diet, and poor hygiene simply because they are deprived of normal social interactions and the motivations attendant on such interactions.

Conventional telephone calls provide a poor substitute for physical visits because they do not permit the concerned relatives or caregivers to see the faces, dress or physical surroundings of their elderly charges. In addition, the elderly do not find disembodied voices on such telephone calls as comforting. Video conferencing could be an alternative to a phone call, but present forms of video conferencing are expensive, technically daunting to operate, and unsatisfying. Such electronic conferences are unsatisfying because even if the parties are connected by an expensive high bandwidth line (such as an ISDN), both the video and audio elements are not delivered real-time, but are troubled by intermittent, jerky disruptions. This is especially true when more than two sites are interconnected or when the connection is otherwise plagued by data delays and dropouts. Such transmissions prevent simultaneous bi-directional interchange, which is commonly available via the conventional telephone service. Thus, conversations over these systems become both artificial sounding and artificial feeling, as parties take care to speak only in turn. The audio and video delays and dropouts of these conference systems becomes even worse when the parties are connected by a shared, more economical, lower bandwidth network, such as the Internet.

Setting the artificiality of the audio and video streams aside, current electronic conference systems are complicated. In fact, they remain difficult to configure and to use on a regular basis even by highly computer literate users. The main reason for these difficulties is that these hardware and software tools have usually been grafted onto general-use personal computer platforms. Such platforms require substantial physical and software configuration of the various accessory items that must be brought together to obtain the desired functionality, including video camera, video digitization card, camera steering motors and their digital interface, microphone, sound digitization card, display monitor, keyboard, pointing device, etc.

For example, in order to initiate a conventional video conference via computer and the Internet, the user must: (1) start the computer, (2) perform various initialization commands for the operating system, (3) select the desired software package, (4) select and initiate communication over the Internet to the desired site, and (5) configure various video display and sound options to control image size, sound level, etc. Of course, in addition to the technical aspects, the user must first contact the other party to arrange for the video conference.

All of these physical interfaces and operational sequences are likely to be confusing and anxiety provoking for the types of individuals who need these conferencing capabilities to assist them in their daily lives rather than as tools of their trade.

What is needed in the art is an electronic conference system which mitigates the problems associated with current systems. Such a new electronic conference tool should improve the transmission of the users' voices and/or images. The system should allow conversations to be casual and authentic, without the delays that have caused present systems to seem artificial and inadequate. Further, what is needed in the art is an electronic conference system which is not cost prohibitive to the consumer, and which offers a well-designed, intuitive user interface which will allow all users, especially those without computer skills, to operate the system. In short, what is needed is something as easy to use, works well, and is as non-threatening as the common telephone.

### BRIEF SUMMARY OF THE INVENTION

The invention is an audio/video conference system particularly suited to one-on-one conferences for electronic caregiving, where the system provides the video portion of the conference through the user's television set via an Internet or other network connection while the audio portion of the conference is provided via a standard telephone line. The system includes an audio/video processor, digital processor, storage, and software to control the user's commands, which include the initiation of an outgoing conference call or the acceptance of an incoming conference call. The system also includes one or more video cameras which can be remotely steered.

### BRIEF DESCRIPTION OF THE DRAWINGS

FIG. 1 is a block diagram of one embodiment of the electronic caregiving system.

FIG. 2 is a flow diagram of an incoming call of a virtual visit.

FIG. 3 is a flow diagram of an outgoing call of a virtual.

FIG. 4 is a graphical user interface for a user receiving an incoming call.

FIG. 5 is a graphical user interface for a user wishing to place an outgoing call.

### DETAILED DESCRIPTION OF THE INVENTION

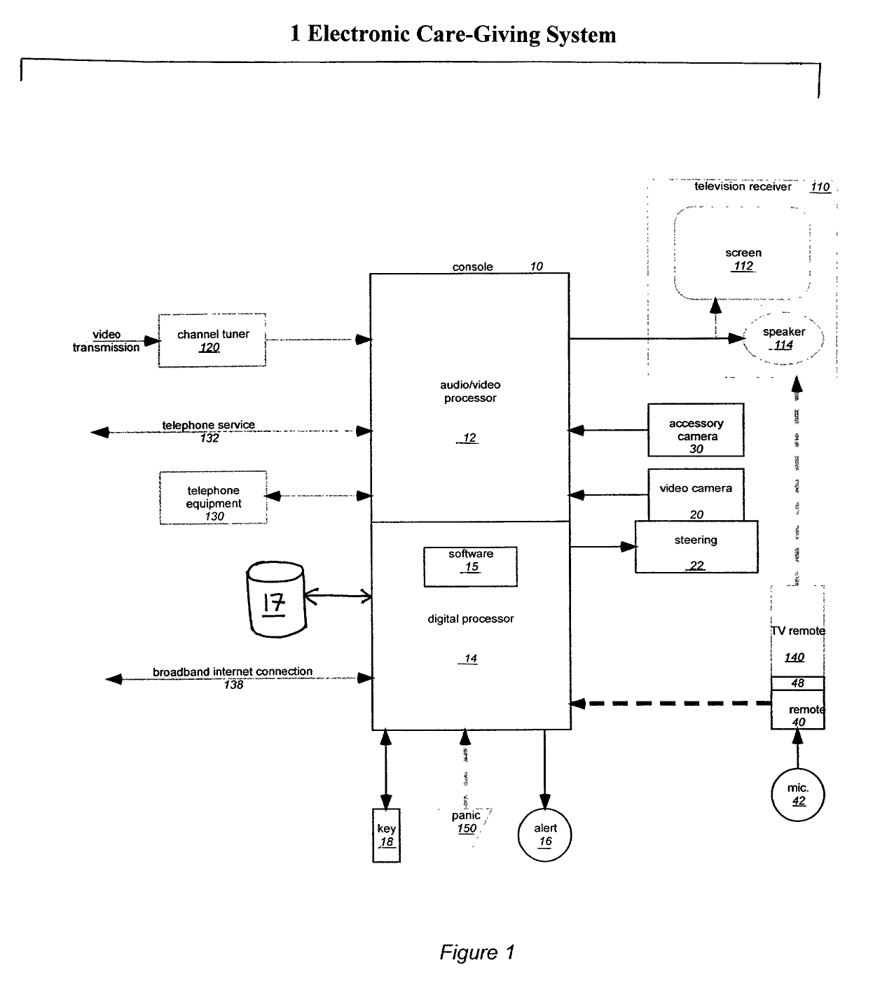

In one preferred embodiment, the electronic caregiving system (1) includes the components shown in the block diagram of FIG. 1. In the drawing, components and signals identified by 3-digit numbers of FIG. 1 denote consumer electronic devices that the user is already likely to have in the home and that can be interfaced with the subject invention by conventional connections. Connections depicted as dashed lines in FIG. 1 are advantageously connections made by wireless means, including but not limited to, radio frequency or infrared light transmission. The normal use of the system requires two more or less identical systems located, for example, in the home of the caregiver user (hereinafter the “caregiver”) and the elderly or disabled user (hereinafter the “primary user”). The components of the system located in the primary user's house are designated in this detailed description by the numbered components identified in FIG. 1; the corresponding components of the system located in the caregiver's home or office are designated with the suffix “A” after the component number.

The Electronic Caregiving System

Referring now to FIG. 1, the electronic caregiving system (1) comprises a console (10), digital processor (14), audio/video processor (12), alert (16), key (18), video camera (20), steering device (22), optional accessory video cameras (30), remote control (40), and means for attachment (48). This system (1) is coupled with a TV remote control (140), television (110), panic button unit (150), telephone equipment (130), and Internet connection (138).

Console (10) houses the digital processor (14), which may be a general purpose personal computer running software (15), and the audio/video processor (12) which is capable of switching, digitizing, and editing audio and video signals as inputs and synthesizing conventional analog audio and video signals as outputs. The console (10) may also house the alert (16), which is a loudspeaker, flashing light, and/or other attention attracting mechanism that notifies users when they should respond to an incoming call.

The key (18) acts as a security device, permitting certain actions to be initiated only by a user in possession of the key (18). Advantageously, the key (18) is capable to receiving, storing, and transmitting personalized digital data to and from the digital processor (14). In FIG. 1, key (18) is configured to couple with the console (10). In other embodiments, key (18) could be configured to couple with remote control (40) or even to exist only virtually as a digital signature key in storage (17).

Video camera (20) and the one or more optional accessory cameras (30) are mounted on steering devices (22) and are controlled by digital processor (14). One or more of these video cameras (20 and/or 30) can be integrated into console (10). One or more of these video cameras (20 and/or 30) could also be mounted in various locations of the user's home.

The remote control unit (40) is equipped with a microphone (42) capable of transmitting verbal commands as well as the user's voice during conversation to digital processor (14). It is preferred that the remote control (40) operate by wireless means so that the user is not bothered by cords.

Because many consumers already have a television remote control (140), the system's own remote control (40) can be coupled to the television remote control (140) with the attachment means (48), thereby simplifying the number and familiarity of appliances that the user must locate and control to operate the system's features, to adjust the volume of the speaker (114), etc. The attachment means (48) might include a caddy with pockets for both remote control units, Velcro brand hook and loop fastener, adhesive tape, or other means of attachment.

The television (110) includes, of course, the screen (112) and one or more speakers (114). The speakers (114) can be configured within the television housing or can be located at various positions within the room. The television (110) can be controlled by the television remote control unit (140). The television (110), cable box, satellite dish box, or other device can include a channel tuner (120) which receives and selects a single channel of composite video from a conventional source of multi-channel video transmission, such as broadcast, cable, or satellite.

The telephone equipment (130) in FIG. 1 may include wired or wireless telephone sets, answering machines, etc., which are connected to conventional telephone service (132). The Internet connection (138) is preferably a broadband connection, such as fiber-optic, coaxial cable, or satellite dish, which is commonly known as an “always on” service.

The panic button (150) is most commonly worn as a pendant by the user and which can be activated in times of distress. When activated, a signal is sent from the panic button (150) to digital processor (14).

In the preferred embodiment, console (10) is placed atop television receiver (110) in a readily accessible location in the primary user's home. When the system (1) is inactive (meaning, there is not presently a call taking place), the conventional electronic appliances attached to it operate in their usual mode, e.g. the video signal selected by channel tuner (120) is sent directly to the television (110) and telephone service (132) is connected to telephone equipment (130). However, when the system (1) is activated either by an outgoing call initiated by the primary user or by an incoming call from a caregiver equipped with another system (1), then console (10) intercepts, modifies and reroutes these signals according to the commands of the primary user as conveyed from remote control unit (40) and interpreted by software (15).

As will be evident by one skilled in the art, many of the components of system (1) are readily available from manufacturers. Some components probably already exist in the primary user's home. For example, television (110), TV remote (140), panic button (150), telephone equipment (130), telephone service (132), and channel tuner (120) exist in most American homes. If not, they can be easily installed. As for the console (10) itself, digital processor (14) and storage (17) can preferably be any standard personal computer having a Pentium 3 or 4 processor running at least 850 MHz with 512 MB SDRAM and perhaps a 60 GB hard drive. The PC will run application-specific software that performs the functions described herein, preferably within a self-booting operating system such as the Windows ME or Windows 2000 operating system.

The audio/video processor (12) can be handled by installing a graphics card and sound card into the PC. For the audio capabilities, since the audio signal does not need to be modulated (simply overriding the audio when needed during calls), only a simple signal switcher and good sound card, such as the Creative Labs Sound Blaster Live! Platinum 5.1 can be used. The system can use the ATI set-top-solutions Rage Theater chip or the TView's TV chipsets. The system may have video pass-throughs that are connected to a video modulator that add the additional menu information to the television image, such as is commonly performed by the picture-in-picture function of many high-end televisions.

Cameras (20 and 30) can be any commercially available higher quality webcam. Intel, Logitech, Sony, and X-10 manufacturer appropriate webcams of this caliber. The camera steering (22) can be accomplished with the use of servos similar to those used in radio controlled planes and cars. Futuba and Airtronics manufacture such servers.

The console (10) and its various related components are fitted with standard TJ45 network jacks, RCA jacks, S-Video jacks, Coax cable jacks, and infrared interface and/or radio frequency interface to interconnect system (1) with the Internet connection (138), telephone equipment (130), telephone service (132), channel tuner (120), and the like.

Flow and System Operation of a Basic Call

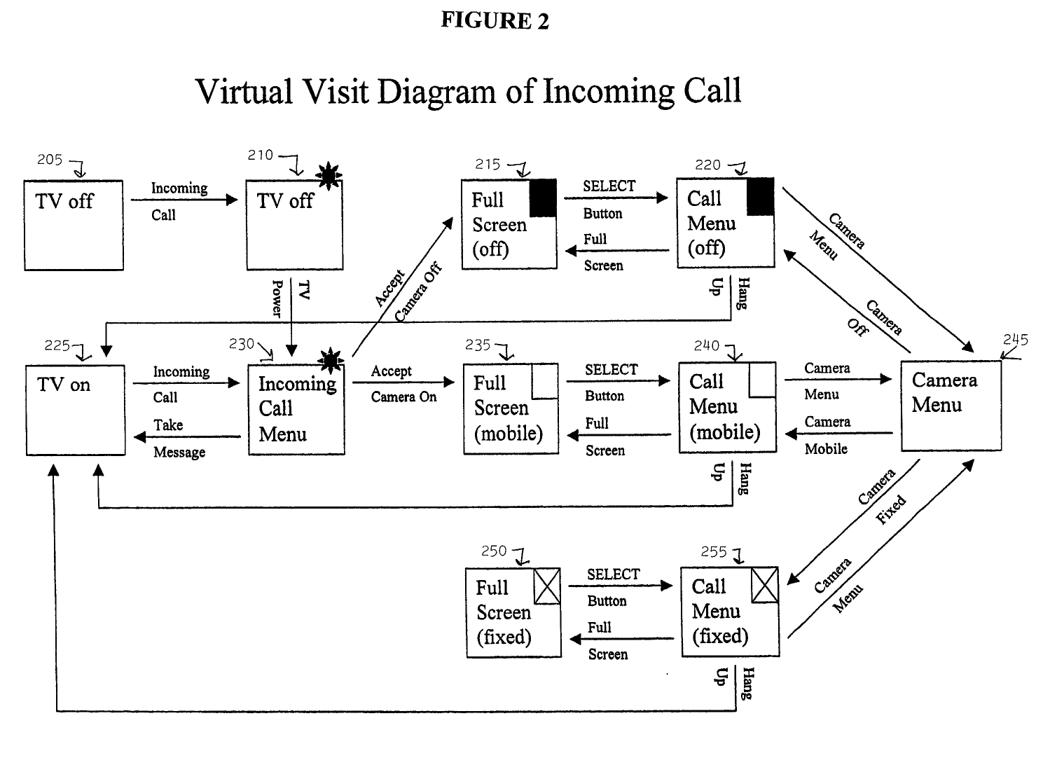

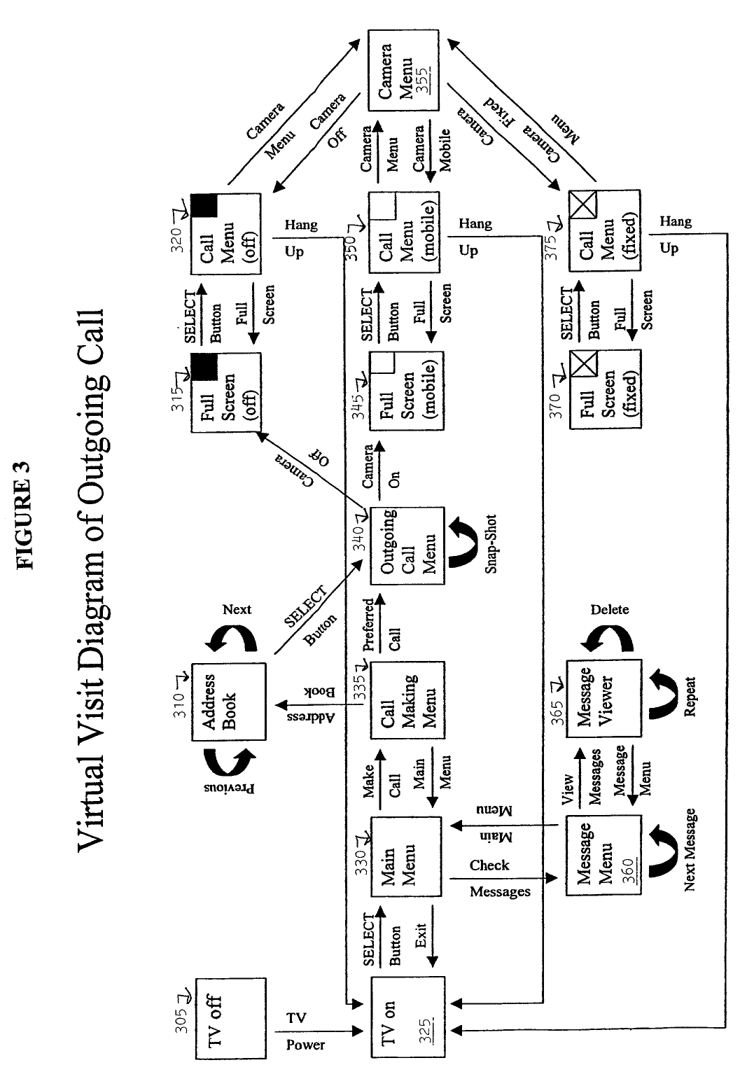

As described above, an object of the invention is to offer a well-designed, intuitive user interface to the system (1) which will allow all users, especially those without computer skills, to operate the system (1). FIGS. 2 and 3 depict one set of flows (of an incoming call and an outgoing call, respectively) of a virtual visit between the caregiver and the primary user. Of course, the flows shown in FIGS. 2 and 3 demonstrate only one of many embodiments possible for the present invention.

Referring to FIGS. 1 and 3, in order to generate an outgoing call (otherwise known as a virtual visit) to a preprogrammed caregiver, the primary user turns on television receiver (110) via TV remote (140) (steps 305 and 325) and activates buttons on remote control (40), thereby conveying his intent to digital processor (14) to initiate a virtual visit or otherwise access the functionality of the system. Audio/video processor (12) intercepts and digitizes the video signal from channel tuner (120), adding display information for transmission to television receiver (110). At step 330, the display information is the main menu of the system.

In one embodiment, at the main menu, only three options are available to the primary user: (A) make call, (B) check messages, and (C) exit. If the user chooses to check messages, at step 360, the message menu is displayed which then presents the primary user with just two options: (A) view messages or (B) return to main menu. If the user views the first message, at step 365, the message is displayed and/or played to the user and then the primary user may (A) repeat the message, (B) delete the message, or (C) return to the message menu. Steps 360 and 365 can be repeated for each subsequent message.

Returning to the main menu (step 330), the primary user can proceed to the call making menu at step 335. At this menu, the user can use remote control (40) to: (A) return to the main menu, (B) place a call to the designated preferred caregiver (which is akin to speed dialing on a telephone), or (C) choose a caregiver to call from the address book. Step 310, which is the address book menu, allows the primary user to move through each preprogrammed destination which is retained in storage (17) and available to digital processor (14).

The primary user utilizes remote control (40) to select the caregiver to be visited and digital processor (14) generates an outgoing request for a visit to the corresponding digital processor (14A) in the console (10A) in the home of the caregiver to be visited. This is conveyed via Internet connection (138). Console (10) also records a video image snapshot of the user and transmits it with the request for a visit to the caregiver's console (10A).

In the home of the caregiver to be visited, receipt of the request for a visit causes alert (16A) to be activated (step 210 of FIG. 2), thereby cueing that caregiver to turn on television receiver (110A) if it is not already on (step 230).

Next, the caregiver's console (10A) uses its audio/video processor (12A) to intercept and digitize the video signal from channel tuner (120A), adding display information for transmission to television receiver (110A). This display information shows the video image of the user requesting the visit and allows the caregiver to select from a limited number of responses on the incoming call menu (step 230) by means of remote control (40A). The caregiver may chose to ignore the request for a visit, whereupon the user requesting the visit will be given the option of leaving a message with both voice and video components (step 225).

The caregiver may also chose to accept the visit as an audio visit only, (step 215) whereupon her audio/visual processor (12A) will initiate an outgoing telephone call via telephone service (132A). This call will be intercepted and answered by audio/video processor (12) in the home of the primary user as an audio only visit (step 315).

The systems of both caregiver and the user will receive audio signals from wireless microphones (42 and 42A) within the remote controls (40 and 40A) instead of from the handsets of telephone equipment (130 and 130A), and the systems will generate audio output that will be emitted by speakers (114 and 114A) by encoding it into the composite video signals sent to television receivers (110 and 110A) or by connecting it to the separate audio signal that is sent to the television receivers (110 and 110A) in place of the audio channel that has been generated from the received broadcast video signal.

Instead of choosing just audio, the caregiver may also chose to accept the visit as an audio-plus-video (“audio+video”) visit (step 235). This will cause activation of the telephone audio channel as described above, plus acquisition and transmission of a video image from video camera (20A). The video image from the caregiver is transmitted via broadband Internet connection (138) to console (10) where it is displayed on screen (112) of television receiver (110) in the home of the primary user.

Notice that the present invention advantageously overcomes problems with the prior art's poor quality audio and visual commonly experienced in video conferences. Under the present invention, the Internet (or other network) connection (138) is used for data exchange as well as video exchange. A standard telephone line (132) and telephone equipment (130) is relied upon for all audio exchanges. By pairing up the use of telephone lines with Internet access, the present invention allows the caregiver and primary user to see each other through use of the video cameras (20 and 30). This video aspect of the electronic caregiving allows the caregiver to physically inspect the health and condition of the primary user. At the same time, the video aspect of the conference soothes the primary user and provides a more realistic virtual visit. Although the video aspect of the conference may indeed suffer from data delays and dropouts, the use of the telephone service (132) for the audio portion of the conference provides excellent communication between the caregiver and the primary user. The audio portion of the present invention is as good as a telephone call because it is in fact a telephone call. Primary users find that because the audio portion of the conference is in real-time, clear, and in full-duplex, the virtual visit is greatly enhanced, even if the video suffers from lack of bandwidth or transmission delays.

When a visit with full audio+video capabilities has been enabled, the caregiver can remotely steer the video camera in the user's location via commands from her remote (40A), and the user can remotely steer the video camera in the caregiver's location via commands from the user's remote control (40) using the system's camera menu (steps 245 and 355). During an audio-plus-video visit, it is advantageous for each party to see both the video image collected from the video camera in the other site plus a smaller version of the video image being collected from the video camera in their own site. This provides a functionality similar to that experienced in face-to-face visits, whereby each party is aware of the current direction of gaze of the other party

Either the caregiver or the user can terminate the virtual visit by using remote (40 or 40A) to select this option, whereupon both consoles (10 and 10A) revert to the default connections that permit the various consumer electronic components to function in their normal manner (Refer to steps 240, 220, 320, 350, and 375).

FIGS. 2 and 3 can be further inspected to walk through one embodiment of the options available when placing an outgoing call (FIG. 3) or receiving an incoming call (FIG. 2). Of course, although the discussion above has dealt with the primary user placing an outgoing call to a caregiver, the system allows the primary user to receive incoming calls from caregivers. Such calls are quite uncomplicated for the primary user—who again may not be technologically savvy. When a call is placed by the caregiver, alert (16) lights up, rings, or otherwise attracts the primary user's attention to the incoming call. The primary user then turns on the TV and simply chooses whether to accept the call in audio mode, accept the call in full audio+video mode, or to refuse the call and allow the caregiver to leave a message.

In addition to the basic features of an incoming or outgoing call (with just audio or audio+video), some embodiments of the present invention offer optional, enhanced functionality, including security keys (18), accessory cameras (30) and panic buttons (150).

First, security key (18) may be inserted into console (110) (or perhaps remote control 40) to enable overrides of the usual reciprocal procedures involved in accepting a visit. This function is similar to giving a house key to a trusted friend or relative so that they can let themselves into the house to check on conditions even when the occupant is not at home or is physically unable to accept visitors.

Second, accessory video cameras (30) may be installed in various locations in the user's home and the caregiver may be enabled to select from the various video signals available instead of the default video camera (20) associated with the console (10). This allows the remote caregiver to inspect more areas of the primary user's house rather than being restricted to the view only near the console (10). FIGS. 2 and 3 include steps which allow a user to restrict a caregiver from accessing the mobile accessory video cameras (30) (see steps 240 and 255 for example) as well as the ability to use such cameras (30) (see steps 350 and 375).

Third, panic call button (150) may be enabled to initiate operation of console (10) in times of emergency. According to preprogramming, activating panic call button (150) would lead to an outgoing call to a predetermined caregiver and/or emergency personal (such as by a 911 phone call).

Of course, one skilled in the art can see that many other enhancements to the system can readily be made. For example, remote (40) could be used for a video zoom that enlarges the central portion of the video image acquired by the remote video camera (20 or 30) before encoding and transmitting it to the other site. Or speech recognition, touch screen, and other forms of data input could be used instead of remote (40), thus allowing primary user to use the system (1) in whatever form is easiest to that user. For example, primary users who are bedridden may benefit from voice recognition capabilities, as could primary users with arthritis which make the remote control (40) difficult to access.

Configuring the System and Additional Considerations

As previously stated, one object of the present invention is to create a system which is designed for ease of use, especially since many users may not be highly computer literate. Thus, rather than having the primary user dial a phone number, or enter a URL or IP address for the caregiver whom the user wishes to call, the requisite information to initiate and receive calls in the preferred embodiment is preprogrammed by a third party operator. The operator interviews the caregiver(s) and primary user to obtain telephone numbers, IP addresses, and other necessary information. Then the operator downloads datafiles to the system's storage unit (17).

Because in its use as an electronic caregiving system, the user will have a pre-set, limited number of caregivers to contact (which may include relatives, neighbors, doctors, pharmacies, pastors, and friends), the third party operator is not needed to initiate most calls. Rather, the operator configures the system (1) to define a small number of predetermined pair-sets. Each pair-set is the information necessary to connect the primary user to one of his or her caregivers. Thus, for example, the third party operator configures a data file to allow the primary user and his physician to call one another; the operator configures another data file to allow the primary user and her son to call one another, etc.

In addition to setting up the configuration files for the various pair-sets so that placing a call is highly automated, the user interface of software (15) is designed to be easily understood by the primary user. In one embodiment, each option presented on television screen (112) to the user has a one-to-one correspondence with physical buttons located on remote control (40). As the preferred embodiment includes a remote control (40) with only five buttons, the system then can present no more than five options to a user at any one time. Thus, in step 203, when the user is informed that a caregiver is trying to contact the user, the primary user is presented with three options: (A) take a message, (B) accept an audio only call, or (C) accept an audio+video call. Each of these three options can be presented to the user so that they correspond to three of the buttons on remote control (40). In one embodiment, each option is displayed on television screen (112) within various simple polygons. For example, the option “take a message” can be presented within a circle while “accept an audio call” is presented within a triangle. Remote control (40) can have buttons which are labeled, colored or shaped as similar polygons to assist the user in easily operating the system.

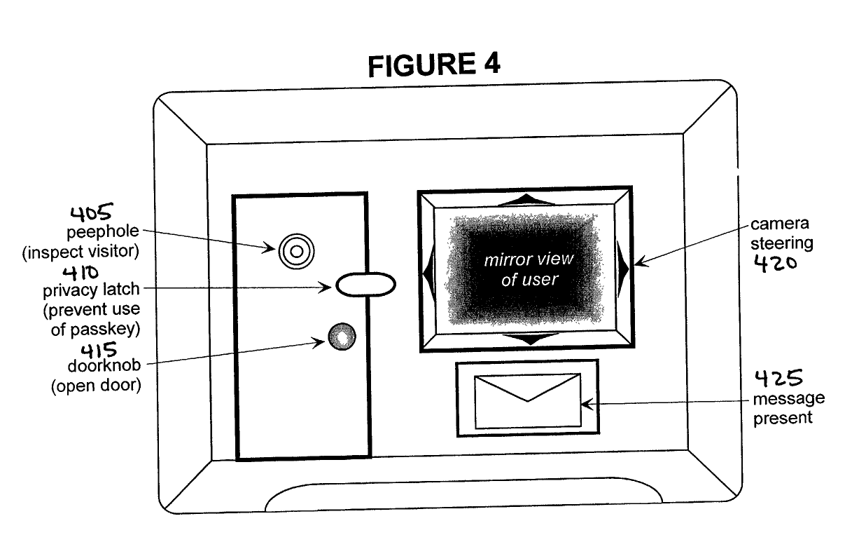

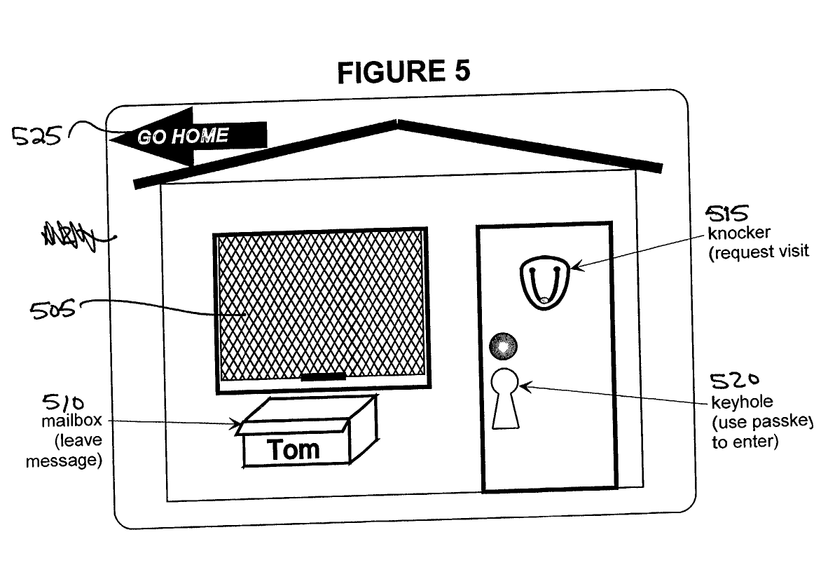

FIGS. 4 and 5 display an alternate means for assisting the user. FIG. 4 is a graphical user interface presented on the television screen 112 when a user receives an incoming call from a caregiver. As FIG. 4 shows, the system presents options iconographically as physical elements within a home's interior that correspond to physical visits. For example, the user can select the peephole (405) at step 230 to find out who the caller is. If the user wishes to speak with the virtual visitor, doorknob (415) can be selected (for step 235) to let the caregiver in. Otherwise, if the call is not answered, mailbox (425) can be checked later to determine whether the virtual visitor left a message.

Similarly, when the user wishes to place an outgoing call, FIG. 5 shows a graphical user interface which is then presented to the user. In this case, the user sees the outside of the caregiver's house. The knocker (515) is selected to place the call. If the user has a passkey, the keyhole (520) can be selected. If no answer is given to the call, a message can be left in the mailbox (510). Anyone skilled in the art will see that there are many different graphical conventions that can be developed to provide user-friendly access to the capabilities enabled by the system. To allow the system to be well suited to its intended audience, the user interface and its icons, as well as the limited flow of options during a conference call (referring back to FIGS. 2 and 3), can be carefully configured to emulate traditional social interactions. Thus, for example, a primary user uses the system (1) in a natural order. As the user interface of FIGS. 4 and 5 illustrate, the system can be set up to display the outgoing image of the primary user as a reflection in a mirror. The user can adjust the virtual mirror which will in turn control the steering of the camera (20).

The hardware and software elements depicted in the preferred embodiment can be augmented by one or more specialized sensors or actuators that may be used to monitoring the health or well-being of the user. These sensing elements can include, but are not be limited to, devices for dispensing or monitoring the usage of medications, devices for detecting motion or sound from remote locations within the home, devices for monitoring physical indicators of health such as body weight, blood pressure, sleep patterns, etc. and devices for monitoring the concentration of particular chemicals in bodily secretions. Information gathered by said specialized sensors would be digitized by digital processor (14) and stored in storage (17) and would be made available only to certain privileged visitors such as authorized medical personnel.

In order to enable visits between specific pair-sets of users, it is necessary for them to agree on the mutually desired level of privileges and to exchange the required destination information to enable their respective consoles (10) to locate each other on the Internet or other general digital communications network. As previously discussed, a third party operator can assist with this process and can have the necessary configuration data files downloaded to the system's storage (17). The data can also be stored or accessed via a security key (18), which is advantageously a portable personal identification and directory storage device. For example, security key (18) can be embodied as a smart card, or as a data file on one of the increasingly popular personal digital assistants (such as the Visor or Palm Pilot PDA).

Security key (18) can be authenticated and configured by a neutral third party, such as the operator. As the present invention comes into general use, security keys will enable users to communicate from remote or public consoles, to authenticate their identity for commercial transactions with merchants to whom they are not personally known, and to make sure that visitors unknown to them are not using stolen security keys. A security key can be used to store various pieces of information, including but not limited to the following about its owner:

Name, physical address and digital home address;

Identification photograph and voiceprint;

Personal directory containing names and digital addresses of usual destinations;

Passwords issued that permit user to access a destination without being invited in by its resident user

Billing information that can be conveyed to obtain goods and services from merchant destinations; and

Name and digital address of user's local operator.

In an embodiment using such a security key (18), when a user purchases a console (10), he or she is assigned to a local operator. This assignment could take the form of a default destination preprogrammed into the system which enables the first audio+video virtual visit to be from the new user to the local operator. The local operator handles the user's account and can read and write information to the user's security key (18). The operator may be a real human operator or a “virtual operator” embodied in a software program containing a sophisticated rule base and high level capabilities for speech, voice and face recognition. The operator can handle various transactions, including but not limited to the following:

Authenticate that the identity of the caller matches the identification information on the security key;

Locate the digital address of the Virtual Visit console that the caller wishes to install as a destination, using common name and physical address information;

Negotiate the acceptance of a proposed link between destinations and install a mutually agreeable level of access privileges on each security key; and

Modify or delete an existing link between destinations.

The user can also handle a number of preprogrammed transactions without operator assistance by means of the message display. These transactions include but are not limited to accepting a proposed destination agreement left as a message, and agree to pay for goods or services by accepting an invoice left as a message.

As users of this invention become more comfortable with the functions described herein, the overall utility of the invention can be expanded by the addition of accessory items. Such accessory items might include conventional data entry devices such as computer keyboards and general purpose web browsing software, in which case the system would come to resemble the general purpose computers and applications software now commonly available. What distinguishes this invention from such general purpose technology is that it can function usefully and completely in the reduced and specialized configuration described herein, thereby permitting users to achieve useful functionality before they achieve sufficient computer literacy to make use of such accessory items.

As the invention described herein comes to be deployed more widely, the overall utility of the invention can be expanded by supporting commercial as well as social transactions. It will be obvious to one skilled in the art that the contents of the security key (18) plus the invention's facilities for face-to-face telemarketing and demonstration of goods and services would be useful in commerce of various kinds and with a wide range of users. Destinations to be visited could include medical clinics, pharmacies, grocery stores, clothiers, etc.

From the foregoing detailed description, it will be evident that there are a number of changes, adaptations and modifications of the present invention which come within the province of those skilled in the art. However, it is intended that all such variations not departing from the spirit of the invention be considered as within the scope thereof.

What is claimed is:

1. An audio/video-call system for allowing communication between a first user and a second user, wherein the communication includes an audio stream, a video stream, and a data stream, the system comprising:
a first and second communication systems separated geographically, wherein the first user and the second user each control one of the communication systems, and wherein each of the communication systems include a video camera, a microphone, an Internet socket for connecting the communication system to the Internet, and a phone socket for connecting the communication system to a phone line;
wherein the Internet is used for sending a data stream initiating a call from the first communication system to the second communication system, and for transmitting the video stream and the data stream between the first and the second communication systems once the call is initiated; and
wherein once the call is initiated, the phone line is used for sending the audio stream between the first user and the second user.

2. The audio/video-call system of claim 1, further comprising a remote control system for issuing commands to the communication systems.

3. The audio/video-call system of claim 2, wherein the remote control system includes a housing containing a set of user-activated buttons, a transmitter, and the microphone;
where in response to the user pressing one of the user-activated buttons, the transmitter sends a command to a television; and
wherein when the user speaks during an audio/visual call, the microphone converts the voice of the user to an audio signal, and the transmitter sends the audio signal to the audio/video call system.

4. The audio/video-call system of claim 1, further comprising a television socket for coupling the first communication system to a television, wherein the video stream and available commands to control the first communication system is displayed on the television.

5. The audio/video-call system of claim 4, wherein the television includes a speaker which broadcasts the audio stream once the call is initiated.

6. The audio/video-call system of claim 1, further comprising a third communication systems; wherein the first communication system can initiate a call with the second communication system or the third communication system.

7. The audio/video-call system of claim 1, wherein the first user is a caregiver and the second user is an elderly or disabled individual.

8. The audio/video-call system of claim 1, further comprising a panic button wirelessly coupled to the second communication system, for the second user to indicate distress and for the second communication system to respond by contacting help.

9. An audio/video-call system for allowing communication between a first user and a second user, wherein the communication includes an audio stream, a video stream, and a data stream, the system comprising:
a communication system controlled by the first user which includes a video camera, a microphone, an Internet socket for connecting the communication system to the Internet, and a phone socket for connecting the communication system to a phone line;
wherein the Internet is used for sending a data stream initiating a call from the communication system, and for transmitting the video stream and the data stream from the communication system once the call is initiated; and
wherein once the call is initiated, the phone line is used for sending the audio stream from the first user.

10. A method for an audio/video-call allowing a first user to communicate with a second user, wherein the communication includes an audio stream, a video stream, and a data stream, the method comprising:
providing a communication system controlled by the first user which includes a video camera, a microphone, an Internet socket for connecting the communication system to the Internet, and a phone socket for connecting the communication system to a phone line;
sending a call request as a data stream over the Internet from the communication system to a geographically separated second communication system;
converting the image of the user to a video signal with the video camera;
sending the video signal as the video stream over the Internet from the communication system to the second communication system once the call request is accepted by the second communication system;
converting the voice of the user to an audio signal with the microphone; and
sending the audio signal as the audio stream over the phone line from the first user to the second user at the second communication system.

11. An audio/video-call system, comprising:
a first and a second communication system for a first and second user respectively, the first and second communication systems connected by at least one network connection;
wherein a request from the first communication system to establish a communication link with the second communication system causes the second communication system to automatically display to the second user a set of choices on a television;
wherein the television is either on or is activated on as a result of the request; and
wherein the response of the second user to one of the set of choices results in the call being established or the call being refused.

12. The audio/video-call system from claim 11, wherein the set of choices displayed to the second user are: “refuse call,” “accept audio call only,” and “accept audio and video call.”

13. The audio/video-call system from claim 11, wherein the second user is a disabled or elderly individual.

14. The audio/video-call system from claim 11, wherein the first user is a caregiver.

15. An audio/video-call system comprising a first and a second communication system which are geographically separated and which are for a first and a second user respectively;
wherein the first and the second communication system each has an Internet socket for connecting to the Internet, thereby coupling the communication systems; and
wherein the first and the second communication systems each have a regular mode of operation which require that for a communication to be established between the two communication systems, the first communication system must initiate a call request to the second communication system and the second communication system must respond with an acceptance to the request; and
wherein the first communication system also has a passkey mode of operation which allows the first communication system to establish communication with the second communication system without the second communication system responding to any request.

16. The audio/video-call system from claim 15, wherein the digital data encoded on a smart card is used to place the first communication system in the passkey mode of operation.

17. The audio/video-call system from claim 15, wherein the digital data stored within the first communication system is used to place the first communication system in the passkey mode of operation.

18. The audio/video-call system from claim 15, wherein the digital data stored within a personal digital assistant is used to place the first communication system in the passkey mode of operation.

19. The audio/video-call system from claim 15, wherein the first user is a caregiver and the second user is an elderly or disabled individual.

20. The audio/video-call system from claim 15, further wherein the first and the second communication system each has a phone socket for connecting to a phone line, thereby coupling the communication systems.

21. A communication system for a user of an audio/video-call system,
wherein the communication system has a memory and an Internet socket for connecting to the Internet and a phone socket for connecting to a phone line; and
wherein without the intervention of the user, an operator downloads a file to the memory which associates an identification object to the telephone number of a person to be called and the network address of the computer of the person to be called.

22. The audio/video-call system from claim 21, wherein the operator retrieves information from a database for the file which is downloaded to the memory.

23. The audio/video-call system from claim 21, wherein the operator communicates with the first user via a phone call.

24. The audio/video-call system from claim 21, wherein the operator communicates with the first user via an audio/video-call.

25. The audio/video-call system from claim 21, wherein the memory is located on a smartcard.

26. A remote control unit for a user of an audio/video conferencing system, the remote control unit comprising:
a housing containing a set of user-activated buttons, a transmitter, and a microphone;
where in response to the user pressing one of the user-activated buttons, the transmitter sends a command to a television; and
wherein when the user speaks during the audio/video conference, the microphone converts the voice of the user to an audio signal, and the transmitter sends the audio signal to the audio/video conferencing system.
